(19) United States
(12) Patent Application Publication
(10) Pub. No.: US 2021/0124343 A1
(43) Pub. Date: Apr. 29, 2021

(54) FIELD DEVICE FOR PROCESS AUTOMATION IN AN INDUSTRIAL ENVIRONMENT

(71) Applicant: VEGA GRIESHABER KG, Wolfach (DE)

(72) Inventors: Juan GARCIA, Biberach (DE); Ralf HOELL, Titisee-Neustadt (DE)

(73) Assignee: VEGA GRIESHABER KG, Wolfach (DE)

(21) Appl. No.: 17/078,350

(22) Filed: Oct. 23, 2020

(30) Foreign Application Priority Data
Oct. 24, 2019 (DE) 10 2019 216 393.9

(51) Int. Cl. G05B 23/02; G05B 19/042

(52) U.S. Cl. CPC G05B 23/0256; G05B 19/0428; G05B 23/0221

(57) ABSTRACT

A field device for process automation in an industrial environment with control circuitry which is configured to generate a plurality of test protocols at different times and to mark each test protocol with a time stamp. The control circuitry is further configured to compare the data of two of the test protocols with each other and to identify differences, as well as to output information about the identified differences as a signal.

### CROSS-REFERENCE TO RELATED APPLICATIONS

This application claims the benefit of the filing date of German Patent Application No. 10 2019 216 393,9 filed on 24 Oct. 2019, the entire content of which is incorporated herein by reference.

### FIELD

The disclosure relates to sensors in an industrial environment. In particular, the disclosure relates to a field device for process automation in an industrial environment, a control unit for a measuring device, a method for a field device for process automation in an industrial environment, a program element and a computer-readable medium.

### BACKGROUND

In an industrial environment, certain field devices are used for process automation. Examples are fill level measuring devices, limit level sensors, pressure measuring devices, flow measuring devices or temperature measuring devices. Test measurements can be carried out to check the function and maintenance of these field devices in order to find out whether the field device provides correct measurement data. This procedure is often costly.

### SUMMARY

It is a task of the present disclosure to make the operation of field devices reliable and efficient.

This task is solved by the features of the independent patent claims. Further developments of the disclosure result from the sub-claims and the following description of embodiments.

A first aspect relates to a field device for process automation in an industrial environment. The field device comprises a control unit which is configured to generate a plurality (two or more) of test protocols at different times and to identify each of these test protocols with a CGS:THU

corresponding time stamp which correlates with the time of generation of the respective test protocol.

The term “process automation in an industrial environment” can be understood as a sub-area of technology, which includes all measures for the operation of machines and plants without human involvement. One goal of process automation is to automate the interaction of individual components of a plant in the chemical, food, pharmaceutical, petroleum, paper, energy, water/waste water, cement, shipping or mining industries. For this purpose a multitude of sensors can be used, which are especially adapted to the specific requirements of the process industry, such as mechanical stability, insensitivity to contamination, extreme temperatures and extreme pressures. Measured values of these sensors are usually transmitted to a control room, where process parameters such as fill level, limit level, flow, pressure or density can be monitored and settings for the entire plant can be changed manually or automatically.

A sub-area of process automation in the industrial environment relates to logistics automation. With help of distance and angle sensors, processes in the field of logistics automation within a building or within a single logistics system are automated. Typical applications are e.g. systems for logistics automation in the area of baggage and freight handling at airports, in the area of traffic monitoring (toll systems), in retail, parcel distribution or also in the area of building security (access control). Common to the examples listed above is that presence detection in combination with an exact measurement of the size and position of an object is required by the respective application side. For this purpose, sensors based on optical measuring methods using lasers, LEDs, 2D cameras or 3D cameras, which measure distances according to the time-of-flight principle (ToF), can be used.

A further sub-area of automation in the industrial environment relates to factory/production automation. Applications for this can be found in the most diverse industries, such as automobile manufacturing, food production, pharmaceutical industry or generally in the field of packaging. The goal of factory automation is to automate the production of goods by machines, production lines and/or robots, i.e. to run it without human intervention. The sensors used in this process and specific requirements with regard to the accuracy of measurement when detecting the position and size of an object are comparable to those used in the previous example of logistics automation.

The field device generates, according to the following conditions, test protocols with individual time stamps. Each test protocol contains a variety of data that correspond to the function of the field device and describe the field device. Examples are raw measurement data, process variables calculated from this data such as level, flow, pressure, density, temperature, etc., but also data that can be seen in the field of diagnostics, such as energy consumption, signal-to-noise ratio, echo width, echo amplitude, status signals, electronics temperature, quartz frequency of the sensor module, information about level echo existence, offsets, adjustment ranges, linearization points, software and hardware statuses, checksums, calibration data validity, drag pointer (pressure, temperature, level, . . . ), time sequences in the sensor, sensor-specific additional protocol points.

The control unit is further configured to compare the data of two of the test protocols (or more than two of the test protocols) with each other and to identify differences autonomously. The control unit is further configured to generate a signal containing information about these identified differences and to output this signal. The field device can be configured to actively output the signal if certain criteria are met, for example if a detected difference exceeds a certain threshold. However, it can also be intended that this signal is queried or requested by a user, for example by reading a memory of the field device.

In a simple case, the signal is an indication that a certain measured variable detected by the field device has irregularities or a peak. This may occur, for example, if the temperature has increased significantly (temperature peak resulting from a drag pointer value), which may happen, for example, during tank cleaning with higher temperatures than during process operation.

According to an embodiment, the control unit is configured to determine the time for generating a test protocol based on a specific trigger event in the field device. Examples of such a trigger event may be a tank cleaning or a related massive change in temperature, a signal from a user or a special measurement event. Further possible trigger events are increased pressure surges at the pressure sensor, caused for example by pressure peaks in the process or also during cleaning by direct irradiation of the cleaning liquid onto the sensor membrane. Or the loss of the echo signal of the radar sensor over a longer period of time, for example caused by strong foam formation in the process or the reduction of the signal-to-noise ratio, for example caused by a very low dielectric constant of the product to be measured. In “intelligent” vibrating limit sensors (next generation of tuning forks currently under development), the vibration frequency may serve as a trigger event when a limit is exceeded. A vibration frequency below a limit indicates that bake-ons may have formed on the tuning fork. An oscillation frequency above a limit indicates that corrosion may have reduced the mass of the tuning forks.

The field device is configured to report such anomalies (identified differences) to a user or at least to store information about them in its memory so that they can be queried at the next opportunity.

According to another embodiment, the control unit is configured to autonomously determine the time for generating a test protocol. This can be time-triggered (e.g. every six months) or event-triggered (e.g. when the level or pressure falls below a certain level). Alternatively or additionally, the time for the creation of the test protocols can also be defined by a user.

According to another embodiment, the signal generated by the control unit does not contain information about all identified differences. For example, threshold values can be defined and only if a difference exceeds the corresponding threshold value, the corresponding signal is generated and output with the information about the identified difference.

The term control unit should be interpreted broadly. This may be a coherent unit. However, the individual components of the control unit may also be arranged in a distributed way. For example, the control unit (circuitry) is designed in the form of a control circuit, an electrical circuit with one or more processors or in the form of another control unit.

In another embodiment, the signal generated by the control unit contains information about future maintenance activities that the control unit has generated taking into account the identified differences. For example, the control unit is configured to output the time and/or the necessary actions that should be taken at a future maintenance.

In another embodiment, the control unit is configured to output an alarm signal if the comparison of the test protocols indicates a malfunction of the field device.

Another aspect relates to a control unit for a measuring device, configured to generate a plurality of test protocols at different times and to mark each test protocol with a time stamp. Each test protocol contains data corresponding to the function of the measuring device. The control unit is configured to compare the data of two of the test protocols and to identify differences, and to generate a signal containing information about the identified differences, to output this signal.

Another aspect relates to a procedure for a field device for process automation in an industrial environment and particularly for the acquisition of measurement data. Several test protocols are generated over time, at different points in time. Each of the generated test protocols is provided with its own time stamp. Each test protocol contains data corresponding to the function of the field device. These data are compared with each other, and differences are identified. A signal is generated which contains information about the identified differences and the signal is output automatically if appropriate.

The method is used for an autonomous generation and storage of test protocols with respective time stamps, which can be started manually or automatically at the field device. According to an embodiment, a generation and visualization of field device-specific data, in particular by determining delta values, from the comparison of the temporally different test protocols or data stored in them is carried out. This can be done automatically. The test protocol data are analyzed internally in the field device with regard to function, maintenance, diagnosis, behavior, . . . , and the result or the evaluation is then forwarded to the user/operator for predictive process optimization via wired, conventional on-site indication/operating displays or also via wireless communication systems (e.g. Bluetooth) to suitable wireless operating devices (e.g. smartphones, tablets) which have the appropriate adjustment programs (e.g. VEGA Tools APP).

Another aspect relates to a program element which, when executed on a control unit of a field device, instructs the field device to perform the steps described above and below.

The computer program may, for example, be loaded and/or stored in a working memory of a data processing device, such as a data processor, wherein the data processing device may also be part of an embodiment. This data processing device may be configured to perform process steps of the method described above. Furthermore, the data processing device may be configured to automatically execute the computer program or the method and/or to execute inputs of a user. The computer program may also be made available over a data network, such as the Internet, and downloaded from such data network into the memory of the data processing equipment. The computer program may also include an update of an existing computer program, which may, for example, enable the existing computer program to perform the procedure described above.

The computer-readable storage medium may in particular, but not necessarily, be a non-volatile medium particularly suitable for storing and/or distributing a computer program. The computer-readable storage medium may be a CD-ROM, a DVD-ROM, an optical storage medium, a solid-state medium or similar, which is supplied together with or as part of other hardware. In addition or alternatively, the computer-readable storage medium may also be distributed or sold in other forms, such as over a data network, such as the Internet or other wired or wireless telecommunications systems. For this purpose, the computer-readable storage medium may be designed as one or more data packets.

Another aspect relates to a computer-readable medium on which a program element described above is stored.

Further embodiments are described below with reference to the figures. The representations in the figures are schematic and not to scale.

### SHORT DESCRIPTION OF THE FIGURES

FIG. 1 shows a field device according to a first embodiment.

FIG. 2 shows a field device according to a second embodiment.

FIG. 3 shows a field device according to a third embodiment.

FIG. 4 shows a flow chart of a method according to another embodiment.

### DETAILED DESCRIPTION OF EMBODIMENTS

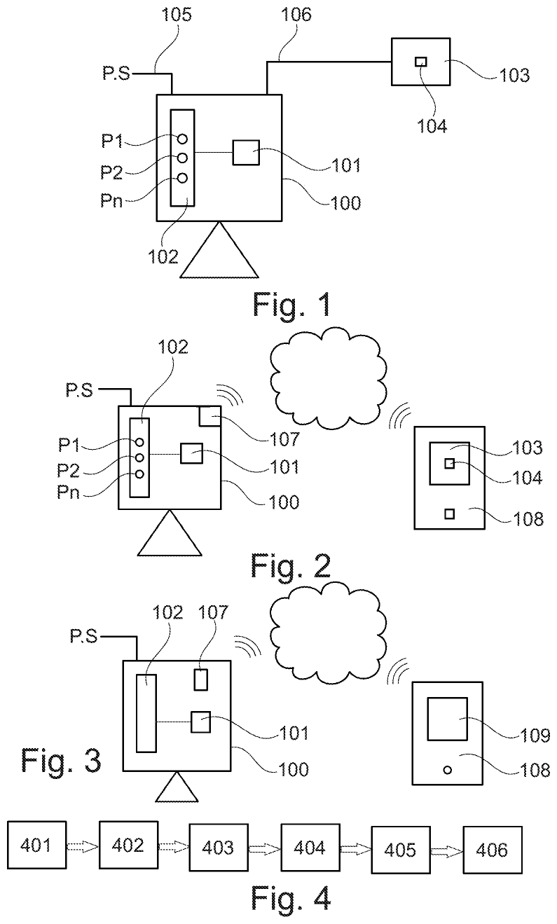

FIG. 1 shows a field device using the example of a radar level sensor 100, which comprises a control unit 101, a memory 102 and a sensor system.

The program element which executes the control unit, with the required device description technologies, such as DTM, based on FDT technology, may, according to an embodiment, generate a test protocol when manually requested, for example via a software switch in the DTM. This may be printed out then by the user or be archived as a file on a data carrier. These test protocols are used by the user for quality control of the field device used, for example to simplify obtaining metrology approvals required by the authorities. The generation of test protocols is only possible because the intelligent field device technology is already equipped with internal test routines and test algorithms.

When a test protocol is requested in the field device, these test routines and test algorithms are started (quasi as an internal function) and used for generating and filling the test protocol. The test protocol can then be used by the operator/user according to the requirements and needs. In the operating program, for example, an internal function is triggered on request (software switch in the DTM) by an operator/user, which generates a kind of negative list. Passing through the individual points of this negative list without determining or detecting errors means as a result that all test points have been found to be good and are marked as “green”, so to speak, so that the test protocol is passed or positive. If individual test points in this negative list are faulty, they are marked as faults or as “red”, so that the test protocol may, under certain circumstances and depending on the weighting of the fault, fail or be negative.

The following describes a procedure for field devices of process and factory automation that can be used for the fast and comfortable transfer of changed configuration data/parameterization data from a manually or automatically and cyclically generated test protocol. The procedure is also used for the autonomous generation of historical test protocols. By determining delta values from the different test protocols with different time stamps, the procedure can also calculate and forward information regarding function, maintenance, diagnosis, behavior, . . . This information can then be visualized on site or in the mobile operating device and ultimately serve the user for anticipatory process optimization.

The disclosure is based on the mechanisms described above and extends them so that the process of generating the test protocols can run autonomously in automated form in addition to the manually controlled procedure. On the one hand, the operator/user can initiate the test protocols manually, e.g. by pressing a button or other control command. On the other hand, the field device can cyclically generate test protocols at different times, which have been set by the operator/user in advance.

These different test protocols are stored in an internal memory 102 in the field device with time stamp. In regular, adjustable time intervals or manually, the field device automatically compares the values of the different test protocols. For example, after each new test protocol with current time stamp, the data of this test protocol is compared with the data of the previously stored test protocol with previous time stamp. The differences, i.e. the delta values of both test protocol parameter sets (i.e. the “data”), are determined and interpreted. From this, a diagnostic trend can be determined.

An increasing antenna contamination may be recognized, for example, by the fact that the signal-to-noise ratio of the echo curve decreases over time. There is already a variable for this in the radar sensors, which is called “measurement reliability”.

With “intelligent” vibrating level switches (next generation of tuning forks, which is currently under development), the vibration frequency may be taken as an indication for bake-ons on the tuning fork or corrosion on the tuning fork. Vibration frequency below a limit indicates that caking on the tuning fork may have formed. Vibration frequency above a limit indicates that corrosion may have reduced the mass of the tuning fork.

Likewise, an increasing deformation of the measuring diaphragm of the pressure sensor may be detected by parameter changes and evaluated accordingly.

In addition, preventive maintenance information/maintenance protocols resulting from changes in the data may be generated automatically. The parameter sets or particularly the determined delta values may be offered or visualized to the user/user in different ways, e.g. conventionally via wired local displays or also via radio directly to wirelessly communicating adjustment/diagnosis devices (e.g. smartphone/tablet/notebook PC) with corresponding adjustment/diagnosis programs (e.g. VEGA Tools APP), which can be found within range of the radio environment (e.g. via Bluetooth standard).

The field device 100 is supplied with external energy (P.S. Power Supply), for example via the 4 . . . 20 mA two-wire interface. The field device generates test protocols of internal field device data in cyclic intervals or manually triggered by an operator/user by means of local keyboard, test button, etc. Test protocols of internal field device data, which are stored as P1 (test protocol for a time point 1) in the internal memory.

At a time point 2, the field device generates a second test protocol with a second field device data set, which is stored under P2 in the internal memory.

At a time point “n”, the field device generates the “nth” protocol with “nth” field device data set, which is also stored in the internal memory.

In parallel to this, the field device compares the recorded test records with each other, depending on its settings for “What” and “When”, and displays differences, e.g. “Delta values”, via the local display connected by cable (“Visualization of the data using the example of P1-P2”).

The control unit 101 is, according to an embodiment, configured to generate a plurality of test protocols at different times and to mark each test protocol with a time stamp, as well as to compare several test protocols with each other and to identify differences between the data or parameters containing the test protocols. If peaks or irregularities are detected, which for example indicate antenna contamination, an already occurred or imminent malfunction of the field device etc., a corresponding signal can be generated and output.

The field device has a power supply 105 and wired communication 106 to a local display with a display 103, which can show the information generated by the control unit.

FIG. 2 shows a field device that is similar to the field device of FIG. 1, but has a radio interface 107 as an alternative or in addition to the wired interface 106, with which the field device can communicate wirelessly with a mobile device 108, so that the calculated information can be displayed on the mobile device.

FIG. 3 shows a field device which is similar to the field device of FIGS. 1 and 2. Today's operating programs, which are equipped with the corresponding device description technologies, such as DTM, based on FDT technology, EDD (Electronic Device Description), future device description languages such as FDI-Package (Field Device Integration Package), or even modern APP in connection with smartphones or tablets, can parameterize and diagnose field devices. With one of these technologies, in connection with the corresponding operating device, the interval for the automatic or manual mode of test protocol generation can be parameterized or started.

In FIG. 3 this is done via a wireless connection between the operating device and the field device. The field device has a wireless communication interface, which is also supported in the mobile operating device. Alternatively, this communication interface can also be designed as a wired interface (e.g. HART interface or service interface, such as I²C).

FIG. 4 shows a flowchart of a method according to a embodiment. In step 401, the field device generates a test protocol at a certain time, which is provided with a corresponding time stamp in step 402 and stored in the field device. In step 403, another test protocol is generated at a later point in time, which was determined autonomously by the field device. In step 404, this test protocol is also provided with a time stamp and stored in the memory. In step 405, all or certain data stored in the two test records are compared and differences are detected. Information is generated from the detected differences and output by means of a signal. With the help of this information, step 406 makes it easier to identify or predict malfunctions of the field device, or to set a time for the next maintenance interval and identify specific maintenance tasks that must then be performed.

This greatly facilitates the operation of field devices.

Further features of designs are described below:

a. Adjustable manual or automated sequence of test protocol generation.

b. Cyclic generation of test protocols with time stamp in the field device.

c. Automated comparison of the parameter sets (data) of the current test protocol with previous test protocols with determination of the different values or delta values.

d. Automatic data checking up to data compression and forwarding of the relevant data, e.g. delta data (data that has changed and must be reported).

e. Transmission or visualization of the delta values to a wired on-site display or wirelessly to operating or diagnostic devices with the corresponding operating and diagnostic program, which can run on smartphones/tablets/PCs.

f. Component for recognition and interpretation of data and transmission of predictive maintenance measures.

g. Adjustability of the automated mode by suitable selection of the interval for the internal test protocol generation, e.g. via software switches using device description languages such as APP/EDD/DTM/FDI package or alternatively in the classic way via on-site display operator displays.

h. If required, external access to the field device. Wired or wireless for accessing the various test protocols with respective time stamps at any time for logging and archiving on external data carriers.

i. If required, the data can also be delivered via gateway interfaces to a central location plant-wide or worldwide, e.g. cloud server.

j. Immediate display/visualization of the data, including continuous updating, to on-site displays (wired data transmission) or to the users/users' mobile operating devices (wireless data transmission).

This may result in the following advantages:

a. Very simple, fast and cyclical testing of the field device by using the manual procedure by means of the software switch/key in the operating program, for example in the DTM, as well as the use of an automated procedure by means of programmable time intervals. For example, the interval can be set to every year, which can be used for an annual WHG (Water Resources Act) test.

b. Local, autonomously in the field device predictive maintenance or error detection.

c. Visualization and forwarding of the delta values, e.g. in the form of characteristic curves or tables.

d. Use of commercially available on-site displays (wired data transmission) or mobile operating devices (wireless data transmission e.g. via Bluetooth).

e. Cost-intensive wired displays on site can be avoided when using wireless transmission technologies such as Bluetooth.

f. When using wireless transmission technologies, the display (mobile operating device) is not fixed at one point, but can be used in the radio radius around the field device or the radio repeater. The user/operator can, for example, do other things besides viewing data and, if necessary, take immediate action with regard to preventive maintenance measures.

In addition, it should be noted that “comprehensive” and “having” does not exclude other elements or steps and the indefinite articles “one” or “one” do not exclude a multitude. It should also be noted that features or steps described with reference to one of the above execution examples can also be used in combination with other features or steps of other execution examples described above. Reference marks in the claims are not to be regarded as restrictions.

1. A field device for process automation in an industrial environment, comprising:
control circuitry configured to
generate a plurality of test protocols at different times, and
identify each test protocol with a time stamp,
wherein each test protocol includes data corresponding to a function of the field device,
wherein the control circuitry is further configured to compare the data of two of the test protocols and identify differences, and
wherein the control circuitry is further configured to generate a signal containing information about the identified differences, and further configured to output said signal.

2. The field device of claim 1,
wherein the control circuitry is further configured to autonomously determine a time for the generation of a test protocol.

3. The field device of claim 2,
wherein the control circuitry is further configured to set the time based on a trigger event in the field device.

4. The field device of claim 1,
wherein the signal generated by the control circuitry does not contain information about all identified differences.

5. The field device of claim 1,
wherein the signal generated by the control circuitry contains information about future maintenance actions, which the control circuitry has generated taking into account the identified differences.

6. The field device of claim 1,
wherein the control circuitry is further configured to output an alarm signal when comparison of the test protocols indicates a malfunction of the field device.

7. A device comprising:
control circuitry, for a measuring device, configured to
generate a plurality of test protocols at different times, and
mark each test protocol with a time stamp,
wherein each test protocol includes data corresponding to the function of the measuring device,
wherein the control circuitry is further configured to compare the data of two of the test protocols and identify differences, and
wherein the control circuitry is further configured to generate a signal containing information about the identified differences and further configured to output said signal.

8. A method for a field device for process automation in an industrial environment, comprising:
generating a plurality of test protocols at different times and marking each test protocol with a time stamp, wherein each test protocol includes data corresponding to the function of the field device;
comparing the data of two of the test protocols and identifying differences;
generating a signal containing information about the identified differences; and
outputting the signal.

9. The method of claim 8, further comprising autonomously determining a time for the generation of a test protocol.

10. The method of claim 9, further comprising setting the time based on a trigger event in the field device.

11. The method of claim 8,
wherein the generated signal does not contain information about all identified differences.

12. The method of claim 8,
wherein the generated signal contains information about future maintenance actions, which have been generated taking into account the identified differences.

13. The method of claim 8, further comprising outputting an alarm signal when comparison of the test protocols indicates a malfunction of the field device.

14. A non-transitory computer readable medium having stored thereon a program element which, when executed by control circuitry of a field device, instructs the field device to perform a method comprising:
generating a plurality of test logs at different times and time stamp each test log, wherein each check log includes data corresponding to the function of the field device;
comparing the data of two of the test logs and identifying differences;
generating a signal containing information about the identified differences; and
outputting the signal.

15. The non-transitory computer readable medium according to claim 14, wherein the method further comprises autonomously determining a time for generation of a test protocol.

16. The non-transitory computer readable medium according to claim 15, wherein the method further comprises further comprises setting the time based on a trigger event in the field device.

17. The non-transitory computer readable medium according to claim 14,
wherein the generated signal does not contain information about all identified differences.

18. The non-transitory computer readable medium according to claim 14,
wherein the generated signal contains information about future maintenance actions, which have been generated taking into account the identified differences.

19. The non-transitory computer readable medium according to claim 14, wherein the method further comprises outputting an alarm signal when comparison of test protocols indicates a malfunction of the field device.
